(19) United States
(12) Patent Application Publication
(10) Pub. No.: US 2014/0337085 A1
(43) Pub. Date: Nov. 13, 2014

(54) CONTEXTUAL SERVICE WORKFLOW RECOMMENDATION USING RANDOM WALK ON SOCIAL NETWORK AND SERVICE NETWORK

(71) Applicant: XEROX CORPORATION, Norwalk, CT (US)

(72) Inventors: Lei Li, Miami, FL (US); Tong Sun, Penfield, NY (US); Hua Liu, Fairport, NY (US)

(73) Assignee: XEROX CORPORATION, Norwalk, CT (US)

(21) Appl. No.: 13/889,545

(22) Filed: May 8, 2013

(51) Int. Cl. G06Q 10/06

(52) U.S. Cl. CPC G06Q 10/0633
USPC 705/7.27

(57) ABSTRACT

The present invention generally relates to systems and methods for recommending specific service instances to fill a service workflow template and complete a user's service goal. Some embodiments utilize both a user trust network and a service trust network. Such embodiments perform a random walk on the service trust network and consider the opinions of trusted neighbors of the customer in the user trust network.

### RELATED APPLICATION

The present disclosure is related to U.S. Patent Application Publication No. 2013-0097046 A1, published on Apr. 18, 2013, and entitled, “Methods And Systems For Recommending Services Based On An Electronic Social Media Trust Model,” which is hereby incorporated by reference herein in its entirety.

### FIELD OF THE INVENTION

This invention relates generally to recommending specific services to achieve a service goal.

### BACKGROUND OF THE INVENTION

In a service marketplace environment, users can use services in sequences, such as workflows, to address complex problems. Due to the large number of services, their functional similarity and combinatorial diversity, multiple workflows can be used to address the same needs. Exhausting all the possibilities is time consuming and practically infeasible for users, and therefore workflow recommendations are needed.

Some traditional approaches to recommending workflows are based on quality of service such as throughput, response time, cost, etc., but ignore the social aspect. Studies show users' previous direct experience and/or indirect experience with service providers play an important role in users' future interactions.

### SUMMARY

According to an embodiment, a method of providing at least one service workflow recommendation is presented. The method includes obtaining a user's service goal. The method also includes comparing the service goal to a plurality of service workflow templates in a stored set of service workflow templates. The method further includes selecting a matching service workflow template from the stored set of service workflow templates based on the comparing, where the matching service template comprises a plurality of service categories, where the plurality of service categories comprise an initial service category. The method further includes selecting at least one initial service matching the initial service category. The method further includes for each of the at least one initial service, repeatedly selecting a next service matching a next service category of the plurality of service categories based on (1) a service network trust of a prior service matching a prior service category of the plurality of service categories of a next service matching a next service category of the plurality of service categories, and (2) a rating of a next service matching a next service category of the plurality of service categories provided by at least one social network neighbor of the user, such that, for each of the at least one initial service, a service workflow is selected. The method further includes providing at least one of the service workflows to the user.

Various optional features of the above embodiment include the following. The obtaining can include obtaining via a computer network. The selecting at least one initial service can include computing a random walk. A plurality of service workflows can be selected, and the method can further include ranking the plurality of service workflows. The ranking can include determining whether at least one service of at least one of the plurality of service workflows is occupied. The repeatedly selecting a next service can include computing a random walk. The providing can include sending over a computer network. At least one service network trust can include a service dependence. At least one rating can include an average of ratings provided by a plurality of social network neighbors of the user. The repeatedly selecting a next service can include computing

$$Pr ( {h}_{{s}_{i} , {T}_{{c}_{0}}}^{( i + 1 )} = {s}_{i + 1} ) = {t}_{{s}_{i} , {s}_{i + 1}}^{S} + \frac{1}{\vert {T}_{{c}_{0}} \vert} {\sum }_{c ∈ {T}_{{c}_{0}}} {r}_{c , {s}_{i + 1}} ,$$

where sᵢ represents a prior service, sᵢ₊₁ represents a next service, is tₛ_{ᵢ}ₛ_{ᵢ₊₁}^{s} represents a trust of service sᵢ of service sᵢ₊₁, T_{c}_{₀} represents social network neighbors of the user, Pr represents a probability, and r_{c,s}_{ᵢ₊₁} represents a rating of service sᵢ₊₁ by customer c.

According to an embodiment, a system for providing at least one service workflow recommendation is presented. The system includes an electronically stored set of service workflow templates. The system also includes at least one processor configured to obtain a user's service goal. The system further includes at least one processor configured to compare the service goal to a plurality of service workflow templates in the stored set of service workflow templates. The system further includes at least one processor configured to select a matching service workflow template from the stored set of service workflow templates, where the matching service template comprises a plurality of service categories, where the plurality of service categories comprise an initial service category. The system further includes at least one processor configured to select at least one initial service matching the initial service category. The system further includes at least one processor configured to, for each of the at least one initial service, repeatedly select a next service matching a next service category of the plurality of service categories based on (1) a service network trust of a prior service matching a prior service category of the plurality of service categories of a next service matching a next service category of the plurality of service categories, and (2) a rating of a next service matching a next service category of the plurality of service categories provided by at least one social network neighbor of the user, such that, for each of the at least one initial service, a service workflow is selected. The system further includes at least one processor configured to provide at least one of the service workflows to the user.

Various optional features of the above embodiment include the following. The at least one processor configured to obtain can include at least one processor configured to obtain via a computer network. The at least one processor configured to select at least one initial service can be further configured to compute a random walk. The system can include at least one processor configured to rank a plurality of service workflows. The at least one processor configured to rank can be further configured to determine whether at least one service of at least one of the plurality of service workflows is occupied. The system can include at least one processor configured to compute a random walk. The system can include a network interface configured to send data over a computer network. At least one service network trust can include a service dependence. The at least one rating can include an average of ratings provided by a plurality of social network neighbors of the user. The system can include at least one processor configured to compute

$$Pr ( {h}_{{s}_{i} , {T}_{{c}_{0}}}^{( i + 1 )} = {s}_{i + 1} ) = {t}_{{s}_{i} , {s}_{i + 1}}^{S} + \frac{1}{\vert {T}_{{c}_{0}} \vert} {\sum }_{c ∈ {T}_{{0}_{o}}} {r}_{c , {s}_{i + 1}} ,$$

where sᵢ represents a prior service, sᵢ₊₁ represents a next service, tₛ_{ᵢ}ₛ_{ᵢ₊₁}^{s} represents a trust of service sᵢ of service sᵢ₊₁, T_{c}_{₀} represents social network neighbors of the user, Pr represents a probability, and r_{c,s}_{₊₁} represents a rating of service sᵢ₊₁ by customer c.

According to an embodiment, a computer readable medium comprising instructions, which, when executed by at least one processor cause the at least one processor to perform the following steps is disclosed: obtaining a user's service goal, comparing the service goal to a plurality of service workflow templates in a stored set of service workflow templates, selecting a matching service workflow template from the stored set of service workflow templates based on the comparing, where the matching service template comprises a plurality of service categories, where the plurality of service categories comprise an initial service category, selecting at least one initial service matching the initial service category, for each of the at least one initial service, repeatedly selecting a next service matching a next service category of the plurality of service categories based on (1) a service network trust of a prior service matching a prior service category of the plurality of service categories of a next service matching a next service category of the plurality of service categories, and (2) a rating of a next service matching a next service category of the plurality of service categories provided by at least one social network neighbor of the user, such that, for each of the at least one initial service, a service workflow is selected, and providing at least one of the service workflows to the user.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 is a schematic diagram of a system according to some embodiments;

FIG. 2 is a schematic diagram of an example service workflow template according to some embodiments;

FIG. 3 is a schematic diagram of an system according to some embodiments; and

FIG. 4 is a flowchart of a method according to some embodiments.

### DESCRIPTION OF THE EMBODIMENTS

Reference will now be made in detail to the present embodiments (exemplary embodiments) of the invention, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean one or more of the listed items can be selected.

A service workflow template is a sequence of services with interrelated dependencies that can fulfill a specific service goal. For example, a service workflow template for the service goal of buying a motor vehicle can include finding agent, confirming production, checking mechanical systems, and paying. In a service workflow template, each item is a service type. Each service type can be fulfilled by any of a variety of specific service instances. Once a service workflow template has specific service instances filled in, it is referred to herein as a “service workflow.”

Service workflow recommendation aims to find specific service instances to fill into a service workflow template. To achieve this goal, some embodiments utilize both a user trust network and a service trust network for service workflow recommendation. By performing a random walk on the service trust network, the interrelated correlations within the recommended service workflows can be well explained and represented, and hence the recommended workflows are cohesive in terms of the dependencies of service items within them. By considering the opinions of trusted neighbors of the customer in the user trust network over the intermediate service items, some embodiments are able to obtain reasonable workflow results with good reputations. The service goal of the customer is thus likely to be satisfied by recommending these well-rated service workflows. By explicitly considering the availability of service items, some embodiments can help customers reduce labor effort of manually evaluating the recommended workflows.

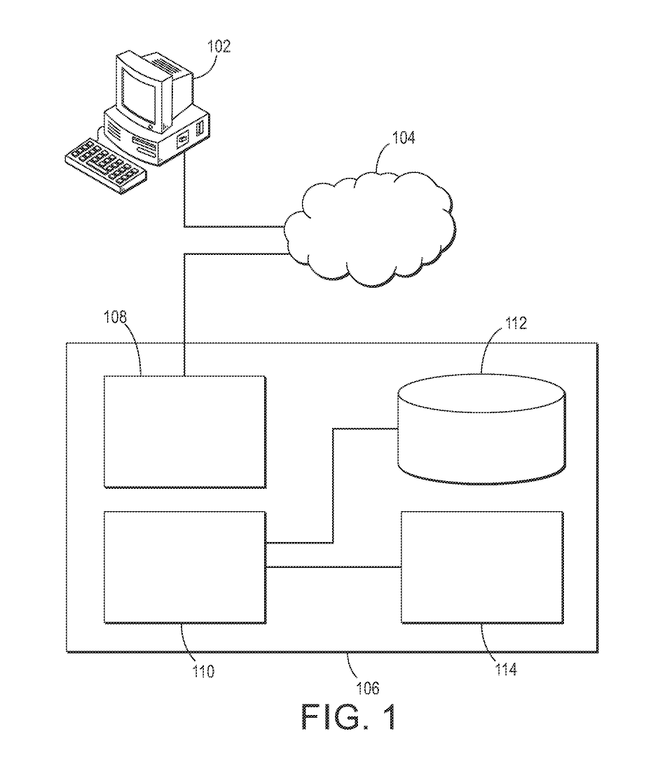

FIG. 1 is a schematic diagram of a system according to some embodiments. In particular, FIG. 1 illustrates various hardware, software, and other resources that may be used in implementations of computer system 106 according to disclosed systems and methods. In embodiments as shown, computer system 106 may include one or more processors 110 coupled to random access memory operating under control of or in conjunction with an operating system. The processors 110 in embodiments may be included in one or more servers, clusters, or other computers or hardware resources, or may be implemented using cloud-based resources. The operating system may be, for example, a distribution of the Linux™ operating system, the Unix™ operating system, or other open-source or proprietary operating system or platform. Processors 110 may communicate with data store 112, such as a hard drive or drive array, to access or store program instructions and other data.

Processors 110 may further communicate via a network interface 108, which in turn may communicate via the one or more networks 104, such as the Internet or other public or private networks, such that a service goal or other information may be received from client 102, or other device or service. Additionally, processors 110 may utilize network interface 108 to send information, instructions, recommended service workflows, or other data to a user via the one or more networks 104. Network interface 104 may include or be communicatively coupled to one or more servers. Client 102 may be, e.g., a personal computer coupled to the internet.

Processors 110 may, in general, be programmed or configured to execute control logic and control operations to implement methods disclosed herein. Processors 110 may be further communicatively coupled (i.e., coupled by way of a communication channel) to co-processors 114. Co-processors 114 can be dedicated hardware and/or firmware components configured to execute the methods disclosed herein. Thus, the methods disclosed herein can be executed by processor 110 and/or co-processors 114.

Other configurations of computer system 106, associated network connections, and other hardware, software, and service resources are possible.

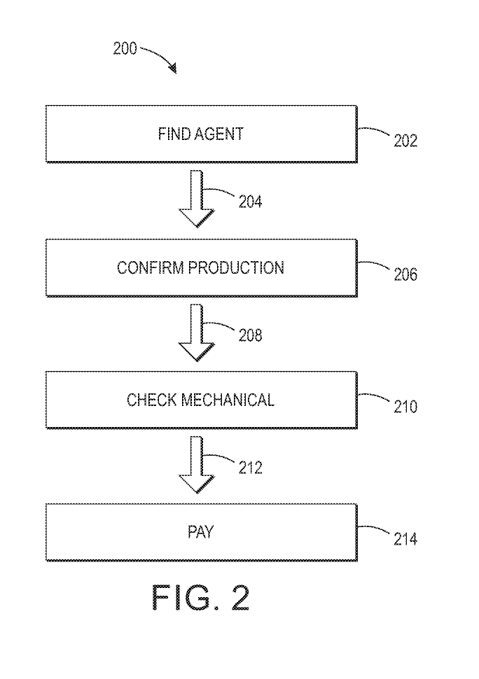

FIG. 2 is a schematic diagram of an example service workflow template 200 according to some embodiments. Service workflow template 200 is intended to meet the service goal of, for example, obtaining a motor vehicle. Service workflow template 200 includes service types 202, 206, 210, and 214, as well as transitions 204, 208, and 212 between the service types. In particular, service workflow template 200 includes, for example, “find agent” service type 202, “confirm production” service type 206, “check mechanical” service type 210, and “pay” service type 214. Each service type 202, 206, 210, and 214 can be filled in with a specific service instance. For example, “pay” service type 206 can be filled by any of the following example specific service instances: provide cash, provide credit card number, implement bank wire transfer, etc. The first service type of a service workflow template is referred to herein as an “initial” service type; in FIG. 2, service type 202 is an initial service type.

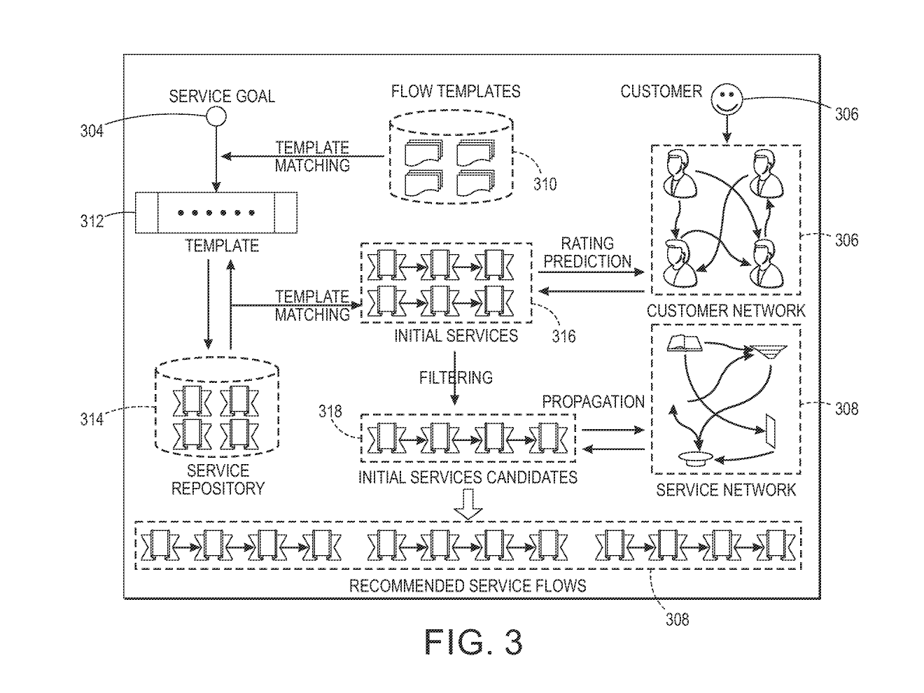

FIG. 3 is a schematic diagram of a system according to some embodiments. The system can be implemented using the components discussed above in reference to FIG. 1, for example. As an overview, the system provides one or more service workflow recommendations by following a procedure that can be conceptualized as two stages. The first stage selects service candidates that match the initial service in a predefined service template. Existing techniques, such as those disclosed in U.S. patent application Ser. No. 13/272,811, entitled, “Methods and Systems for Recommending Services Based on an Electronic Social Media Trust Model”, can be used to select such an initial service. The second stage extends the initial service(s) to one or more service workflows under the constraint of the template by using a random walk on a service trust network and by quality evaluation of the generated workflow(s) derived through the user trust network.

A detailed explanation of FIG. 3 follows. The system obtains service goal 304 by, for example, receiving an input from a user of client 102. The input can be entered free-form, or selected from a list of service goals. The system then matches service goal 304 to a service workflow template stored in template repository 310, which can exist on, e.g., data store 112. The system selects matching service template 312 based on the service goal 304 matching process. Note that service workflow 312 template defines the general steps that can achieve service goal 304 and includes a series of service types to restrict the selection of specific services. Note further that service workflow template 312 includes an initial service type at its start.

After obtaining service workflow template 312, the system automatically selects a service type that service workflow template 312 describes from service network 308, and identifies in service repository 314 a set of initial services 316 in the selected service type that match with the initial service type of service workflow template 312. The selected services can then be filtered by the process of U.S. patent application Ser. No. 13/272,811, entitled, “Methods And Systems For Recommending Services Based On An Electronic Social Media Trust Model” to provide a set of one or more initial service candidates 318.

Once the system obtains filtered initial service candidates 318, the system performs service workflow recommendation by selecting a series of services for each initial service candidate 318 from service trust network 308. To this end, the system performs a random walk on service trust network 308, taking each initial service candidate 318 as the starting point. After propagating all the service workflows, the system can use a service workflow quality measurement to evaluate the quality of the service workflows, and then rank them based on the quality score to achieve a ranked set of recommended service workflows 320. The system then presents the ranked set of recommended service workflows 320 to customer 302.

The process of building service workflows starting from one or more initial service candidates 318, referred to herein as “propagation,” is discussed in detail presently. In general, the system performs a random walk on service trust network 308. Service trust network 308 is independent from the service usage logs, where the trust correlations between services are derived from the service usage logs. For example, in the service usage log, a service A might often be followed by service B, i.e., customers frequently use B after using A. In this case, there might be a dependence between service A and service B, which can also be regarded as a trust correlation, denoted AB. To provide high-quality service workflows, the system incorporates ratings on the service being selected from the direct trusted neighbors of customer 302 within customer network 306, e.g., to consult opinions of customers trusted by customer 302. In this way, the quality of the selected services is evaluated based on not only the trust of its dependent services, but also the trust of the customer's collaborators or friends. Such envisioned trust enrichment can provide more reasonable service workflow recommendation in terms of the suitableness of the workflow to service goal 304 of customer 302.

The random walk on service trust network 308 is constrained by service template 312 and enriched by the customers' ratings obtained from customer network 306. For the random walk, denote an initial service by s₀. The maximal depth of the random walk is restricted by service template 312, i.e., the length of service series defined in service template 312. At each step i of the random walk, denote a specific service by sᵢ. To trigger the next step, the system first filters the service set that sᵢ on to remove unrelated services based on the i-th service restriction in service template 312. Then, for the remaining services, the system defines a hidden variable

$${h}_{{s}_{i} , {T}_{{c}_{0}}}^{( i + 1 )}$$

for selecting a service sᵢ₊₁ based on the previous selected service sᵢ and the direct trusted neighbors T_{c}_{₀} of customer c₀ 302. The hidden variable can be formalized, by way of non-limiting example, according to the following.

$$Pr ( {h}_{{s}_{i} , {T}_{{c}_{0}}}^{( i + 1 )} = {s}_{i + 1} ) = {t}_{{s}_{i} , {s}_{i + 1}}^{S} + \frac{1}{\vert {T}_{{c}_{0}} \vert} {\sum }_{c ∈ {T}_{{c}_{0}}} {r}_{c , {s}_{i + 1}} \qquad ( 1 )$$

In Equation (1), the first component, tₛ_{ᵢ}ₛ_{ᵢ₊₁}^{s}, denotes the trust of service sᵢ on service sᵢ₊₁, and the second component,

$$\frac{1}{\vert {T}_{{c}_{0}} \vert} {\sum }_{c ∈ {T}_{{c}_{0}}} {r}_{c , {s}_{i + 1}} ,$$

is the averaged rating on service sᵢ₊₁ from the direct trusted neighbors in customer network 306 of customer 302. To make

$$Pr ( {h}_{{s}_{i} , {T}_{{c}_{0}}}^{( i + 1 )} = {s}_{i + 1} ) ∈ [ 0 , 1 ] ,$$

these two components can be normalized (e.g., each normalized to ½) before the linear combination. The output of executing Equation (1) contains a set of service workflows that are likely to fulfill service goal 304 of customer 302.

The Table below provides an example, non-limiting process for executing the above-described procedure utilizing Equation (1).

TABLE
Data: Service Trust Network [symbol] ,

Customer Trust Network [symbol] ,
Service Template [symbol] ,
Initial Service s₀ and Customer c₀.

Result: Service Workflow [symbol] Started from s₀.
Initialize service chain: [symbol] .append(s₀);
begin

| \| | T_{c}_{₀} ← DirectTrustedNeighbors(c₀); | |
|---|---|---|
| \| | for i ← 0 to [symbol] − 1 do | |
| \| | \| | $Calculate Pr ( {h}_{{s}_{i} , {T}_{{c}_{0}}}^{( i + 1 )} = {s}_{i + 1} ) = {t}_{{s}_{i} , {s}_{i + 1}}^{S} + \frac{1}{\vert {T}_{{c}_{0}} \vert} {\sum }_{c ∈ {T}_{{c}_{0}}} {r}_{c , {s}_{i + 1}} ;$ |
| \| | \| | $Select {\hat{s}}_{i + 1} with the largest Pr ( {h}_{{s}_{i} , {T}_{{c}_{0}}}^{( i + 1 )} = {s}_{i + 1} ) ;$ |
| \| | \| | [symbol] .append(sᵢ₊₁); |

| | |
|---|---|
| \| | end |
| \| | Return [symbol] , |

end

Once the system obtains a set of service workflows that are likely to fulfill service goal 304 of customer 302, the system can optionally rank them before presentation to customer 302. The ranking can be based on, e.g., the quality of the service workflows. The quality of a service workflow can be defined based on the availability of services in a given service workflow at the current timestamp. In general, high-quality services might be occupied by some customers in the current timestamp, and also there might be a queue of customers waiting to use the service. In such a scenario, this type of service workflow might not satisfy the instant requirement of specific customers, and therefore the ranking of the service workflow should be lower than an idle one or one with less customers in queue. Thus, some embodiments evaluates service workflow availability using three example, non-limiting rules. First, the ranking considers whether or not the given service workflow is occupied. Second, the ranking considers, for occupied service workflows, how many customers are on the associated list. Third, the ranking considers the length of the average usage time of the given occupied service workflow. These rules can be combined in various ways. For example, in some embodiments, the first rule has the highest priority when ranking service flows, and the second and third rules are considered in an integrated manner.

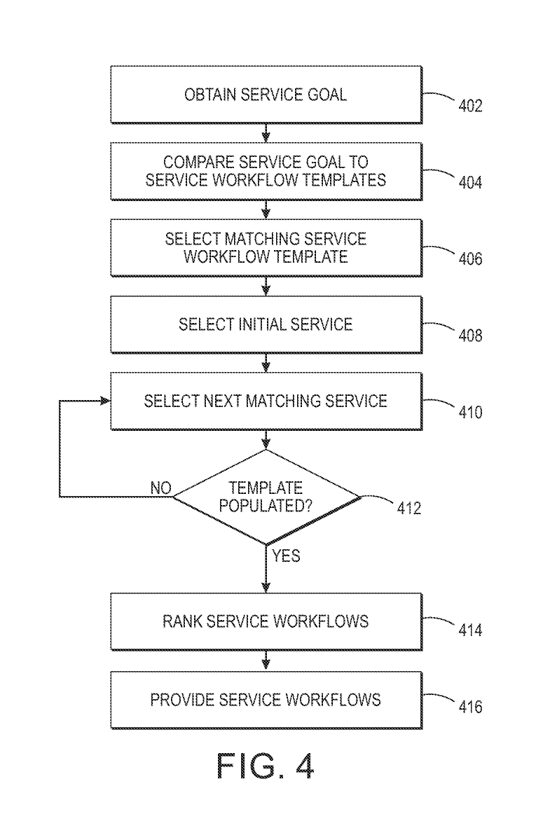

FIG. 4 is a flowchart of a method according to some embodiments. The method of FIG. 4 can be implemented using the system of FIG. 1 and/or FIG. 3. At block 402, the method obtains a service goal from a customer. The method can obtain the service goal, e.g., input by a customer into a web-based form and conveyed to a computer system, e.g., 106 of FIG. 1.

At block 404, the method compares the service goal to a stored set of service workflow templates. The comparison process can utilize, e.g., fuzzy string matching heuristics. At block 406, the method selects a matching service workflow template based on the comparison process of block 404.

At block 408, the method selects one or more initial services to fill the initial service type of the service workflow template selected at block 406. The method can utilize any known technique for this process, e.g., U.S. patent application Ser. No. 13/272,811, entitled, “Methods And Systems For Recommending Services Based On An Electronic Social Media Trust Model”.

At block 410, the method selects a next matching service for the partial service workflows being operated on. Thus, for example, starting from an initial service, the method would select a second service at this block. The selection of the next matching service can be accomplished using, e.g., the techniques discussed above in reference to FIG. 3, such as those presented concisely according to algorithm of Table 1 above.

At block 412, the method determines whether the service workflow template is fully populated by the services selected up to this point. That is, for each initial service selected at block 408, the method determines whether the propagation process is complete as determined by the length of the service workflow template. If not, the process branches back to block 410 to select the next matching service. If so, the process proceeds to block 414.

At block 414, the method has produced one or more service workflows matching the service workflow template. The process at this block proceeds to rank such service workflows. The ranking can be accomplished as discussed above in reference to recommended service workflows 320 of FIG. 3 above.

At block 416, the method provides the service workflows to the customer. The providing can be accomplished by, e.g., conveying the service workflows to client 102 of FIG. 1 over a network such as the internet.

Certain embodiments can be performed as a computer program or set of programs. The computer programs can exist in a variety of forms both active and inactive. For example, the computer programs can exist as software program(s) comprised of program instructions in source code, object code, executable code or other formats; firmware program(s), or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A computer implemented method providing at least one service workflow recommendation, the method comprising:
obtaining a user's service goal;
comparing the service goal to a plurality of service workflow templates in a stored set of service workflow templates;
selecting a matching service workflow template from the stored set of service workflow templates based on the comparing, wherein the matching service template comprises a plurality of service categories, wherein the plurality of service categories comprise an initial service category;
selecting at least one initial service matching the initial service category;
for each of the at least one initial service, repeatedly selecting a next service matching a next service category of the plurality of service categories based on (1) a service network trust of a prior service matching a prior service category of the plurality of service categories of a next service matching a next service category of the plurality of service categories, and (2) a rating of a next service matching a next service category of the plurality of service categories provided by at least one social network neighbor of the user, whereby, for each of the at least one initial service, a service workflow is selected; and
providing at least one of the service workflows to the user.

2. The method of claim 1, wherein the obtaining comprises obtaining via a computer network.

3. The method of claim 1, wherein the selecting at least one initial service comprises computing a random walk.

4. The method of claim 1, whereby a plurality of service workflows are selected, the method further comprising ranking the plurality of service workflows.

5. The method of claim 4, wherein the ranking comprises determining whether at least one service of at least one of the plurality of service workflows is occupied.

6. The method of claim 1, wherein the repeatedly selecting a next service comprises computing a random walk.

7. The method of claim 1, wherein the providing comprises sending over a computer network.

8. The method of claim 1, wherein at least one service network trust comprises a service dependence.

9. The method of claim 1, wherein at least one rating comprises an average of ratings provided by a plurality of social network neighbors of the user.

10. The method of claim 1, wherein the repeatedly selecting a next service comprises computing
$$Pr ( {h}_{{s}_{i} , {T}_{{c}_{0}}}^{( i + 1 )} = {s}_{i + 1} ) = {t}_{{s}_{i} , {s}_{i + 1}}^{S} + \frac{1}{\vert {T}_{{c}_{0}} \vert} {\sum }_{c ∈ {T}_{{c}_{0}}} {r}_{c , {s}_{i + 1}} ,$$
where sᵢ represents a prior service, sᵢ₊₁ represents a next service, tₛ_{ᵢ}ₛ_{ᵢ₊₁}^{s} represents a trust of service sᵢ of service sᵢ₊₁, T_{c}_{₀} represents social network neighbors of the user, Pr represents a probability, and r_{c,s}_{ᵢ₊₁} represents a rating of service sᵢ₊₁ by customer c.

11. A system for providing at least one service workflow recommendation, the system comprising:
an electronically stored set of service workflow templates;
at least one processor configured to obtain a user's service goal;
at least one processor configured to compare the service goal to a plurality of service workflow templates in the stored set of service workflow templates;
at least one processor configured to select a matching service workflow template from the stored set of service workflow templates, wherein the matching service template comprises a plurality of service categories, wherein the plurality of service categories comprise an initial service category;
at least one processor configured to select at least one initial service matching the initial service category;
at least one processor configured to, for each of the at least one initial service, repeatedly select a next service matching a next service category of the plurality of service categories based on (1) a service network trust of a prior service matching a prior service category of the plurality of service categories of a next service matching a next service category of the plurality of service categories, and (2) a rating of a next service matching a next service category of the plurality of service categories provided by at least one social network neighbor of the user, whereby, for each of the at least one initial service, a service workflow is selected; and
at least one processor configured to provide at least one of the service workflows to the user.

12. The system of claim 11, wherein the at least one processor configured to obtain comprises at least one processor configured to obtain via a computer network.

13. The system of claim system 11, wherein the at least one processor configured to select at least one initial service is further configured to compute a random walk.

14. The system of claim 11, further comprising at least one processor configured to rank a plurality of service workflows.

15. The system of claim 14, wherein the at least one processor configured to rank is further configured to determine whether at least one service of at least one of the plurality of service workflows is occupied.

16. The system of claim 11, further comprising at least one processor configured to compute a random walk.

17. The system of claim 11, further comprising a network interface configured to send data over a computer network.

18. The system of claim 11, wherein at least one service network trust comprises a service dependence.

19. The system of claim 11, wherein at least one rating comprises an average of ratings provided by a plurality of social network neighbors of the user.

20. The system of claim 11, further comprising at least one processor configured to compute
$$Pr ( {h}_{{s}_{i} , {T}_{{c}_{0}}}^{( i + 1 )} = {s}_{i + 1} ) = {t}_{{s}_{i} , {s}_{i + 1}}^{S} + \frac{1}{\vert {T}_{{c}_{0}} \vert} {\sum }_{c ∈ {T}_{{c}_{0}}} {r}_{c , {s}_{i + 1}} ,$$
where sᵢ represents a prior service, sᵢ₊₁ represents a next service, tₛ_{ᵢ}ₛ_{ᵢ₊₁}^{s} represents a trust of service sᵢ of service sᵢ₊₁, T_{c}_{₀} represents social network neighbors of the user, Pr represents a probability, and r_{c,s}_{ᵢ₊₁} represents a rating of service sᵢ₊₁ by customer c.

21. A computer readable medium comprising instructions, which, when executed by at least one processor cause the at least one processor to perform:
obtaining a user's service goal;
comparing the service goal to a plurality of service workflow templates in a stored set of service workflow templates;
selecting a matching service workflow template from the stored set of service workflow templates based on the comparing, wherein the matching service template comprises a plurality of service categories, wherein the plurality of service categories comprise an initial service category;
selecting at least one initial service matching the initial service category;
for each of the at least one initial service, repeatedly selecting a next service matching a next service category of the plurality of service categories based on (1) a service network trust of a prior service matching a prior service category of the plurality of service categories of a next service matching a next service category of the plurality of service categories, and (2) a rating of a next service matching a next service category of the plurality of service categories provided by at least one social network neighbor of the user, whereby, for each of the at least one initial service, a service workflow is selected; and
providing at least one of the service workflows to the user.
